(19) United States
(12) Patent Application Publication
(10) Pub. No.: US 2023/0088304 A1
(43) Pub. Date: Mar. 23, 2023

(54) SECURE COMPUTING SYSTEM FOR ATTESTATION OF SECURED CODE, DATA AND EXECUTION FLOWS

(71) Applicant: Kameleonsec, Inc., Mountain View, CA (US)

(72) Inventors: Aviram SHEMESH, Haifa (IL); Nissan ALONI, Zoran (IL); Ido NAISHTEIN, Mishmarot (IL)

(73) Assignee: Kameleonsec, Inc., Mountain View, CA (US)

(21) Appl. No.: 17/481,972

(22) Filed: Sep. 22, 2021

(51) Int. Cl. G06F 21/52

(52) U.S. Cl. CPC G06F 21/52; G06F 2221/032

(57) ABSTRACT

A computing system and method for attestation of secured code, data and execution flows are provided. The computing system includes a processing circuitry; a memory communicatively connected to the processing circuity, the memory containing therein a protected code; and a protector circuitry connected to the processing circuitry; such that upon execution of the protected code by the processing circuitry the computing system is configured to: initialize the protector engine; perform at least one static protection check using the protector circuitry; perform at least one dynamic protection checks using the protector circuitry; and generate a notification upon detection of an error in any one the at least one static check and the at least one dynamic check.

### TECHNICAL FIELD

The present disclosure relates generally to system security, and more particularly to a computing system executing protected code, data and process flows using code specifically compiled for attestation thereof.

### BACKGROUND

As computer systems become increasingly complex and interconnected, the need for increased security is paramount. In response to modern computer networks growing increasingly sophisticated, potential attackers diligently search for security lapses to breach safety measures present in various systems. The established protocols of running anti-virus applications and inserting firewalls between an internal system and, for example, the internet, no longer offer sufficient protection on their own. One challenge presented in running software is ensuring that a bad actor cannot gain access to the processes executing safety functions under the same environment or operating system, as this may allow malware to be inserted, may allow confidential information about the software to be exposed, and the like.

It has been long-established that current software solutions are susceptible to tempering by any other code or device that may have access to the system memory or disk storage. This may be achieved by altering the code, data, or execution of the attacked program. Operating under the same host system, any program with the same permissions level or higher, can interfere or change the running code. For example, rootkits are a strain of malware, i.e., malicious software, designed to enable access to a computer or an area of its software that it should not otherwise be permitted to access. Rootkits are known for their design that allows them to change the operating system code and data. It is capable of hiding itself, or the perpetrator malware files, by subverting the host system code. This is done at any software level and on any of the different system permission rings. Subverting software code is achievable on both disk (also referred to as static patching where the software binary information is altered prior to execution on the system) and memory (also referred to as dynamic patching, from where the software binary code executes on the system CPU, and the attacker changes it during its execution). In either case the effects of code alteration are affect the system when executed.

One way the existing solutions attempt to address these issues is to try and identify these cases by using a variety of system and software solutions. These try to identify the perpetrator and eliminate it in various ways, during execution time or passive scanning mechanisms done post breach time and are designed in order to avoid the farther system compromise. However, it is necessary to identify such malware, update the systems accordingly and then it may be possible to identify a particular type of attack. In more modern system various artificial intelligence (AI) solutions are employed. However, AI-based solutions like their predecessors take time to identify the perpetrator's characteristics before they can effectively eradicate its impact on the attacked system.

It would therefore be advantageous to provide a solution that would overcome the challenges noted above.

### SUMMARY

A summary of several example embodiments of the disclosure follows. This summary is provided for the convenience of the reader to provide a basic understanding of such embodiments and does not wholly define the breadth of the disclosure. This summary is not an extensive overview of all contemplated embodiments, and is intended to neither identify key or critical elements of all embodiments nor to delineate the scope of any or all aspects. Its sole purpose is to present some concepts of one or more embodiments in a simplified form as a prelude to the more detailed description that is presented later. For convenience, the term “certain embodiments” may be used herein to refer to a single embodiment or multiple embodiments of the disclosure.

Certain embodiments disclosed herein include a computing system attestation of secured code, data and execution flows. The computing system includes a processing circuitry; a memory communicatively connected to the processing circuity, the memory containing therein a protected code; and a protector circuitry connected to the processing circuitry; such that upon execution of the protected code by the processing circuitry the computing system is configured to: initialize the protector engine; perform at least one static protection check using the protector circuitry; perform at least one dynamic protection checks using the protector circuitry; and generate a notification upon detection of an error in any one the at least one static check and the at least one dynamic check.

Certain embodiments disclosed herein also include a method for attestation of secured code, data and execution flows. The method includes initializing a protector circuitry executed over a processor circuity; performing at least one static protection check using the protector circuitry; performing at least one dynamic protection checks using the protector circuitry; and generating a notification upon detection of an error in any one the at least one static check and the at least one dynamic check.

### BRIEF DESCRIPTION OF THE DRAWINGS

The subject matter disclosed herein is particularly pointed out and distinctly claimed in the claims at the conclusion of the specification. The foregoing and other objects, features, and advantages of the disclosed embodiments will be apparent from the following detailed description taken in conjunction with the accompanying drawings.

FIG. 1 is a block diagram illustrating a computer system executing protected code adapted for attestation of code, data and process flows according to an embodiment.

FIG. 2 is a flowchart of the operation of the computer system executing protected code adapted for attestation of code, data and process flows according to an embodiment.

FIG. 3 shows a full attestation flow from compiler to execution according to an embodiment.

FIG. 4 is a system with a compiler and a computing system adapted for attestation of code, data and process flows according to an embodiment.

FIG. 5 is an example of protected compiled code read and write validator and read and XOR validator as outputted by the compiler add-on according to an embodiment.

### DETAILED DESCRIPTION

It is important to note that the embodiments disclosed herein are only examples of the many advantageous uses of the innovative teachings herein. In general, statements made in the specification of the present application do not necessarily limit any of the various claimed embodiments. Moreover, some statements may apply to some inventive features but not to others. In general, unless otherwise indicated, singular elements may be in plural and vice versa with no loss of generality. In the drawings, like numerals refer to like parts through several views.

For the various embodiments disclosed herein, a protected code is provided by a compiler with a compiler add-on, where the compiler add-on is adapted to provide code, data and execution flow attestation in the context of a secure computing system. Accordingly, upon the generation of a compiled code, i.e., generation of assembly code of a software program by the compiler, the compiler add-on provides additional code that is targeted to provide additional security level. By adding one or more validators which are program units that alert of potential discrepancies between expected and actual performance, as well as execution proofs, the secured compiled code delivers maximum protection during runtime. The series of protections added by the compiler add-on complement each other and thus prevent exploitation of weaknesses if and when they exist. As a result, a complete runtime trusted computing base (TCB) code instance even if in a hostile system is achieved. Further details of such a compiler system are provided in U.S. patent application Ser. No. 17/481,669 titled “COMPILER ADD-ON FOR CODE, DATA AND EXECUTION FLOWS ATTESTATION IN A SECURE COMPUTING SYSTEM,” (hereinafter after the “'669 Application”) filed on the same day and date, assigned to common assignee, and that is hereby incorporated by reference for all that it contains.

The code provided by the compiler, after the additions provided by the compiler add-on, all for real time attestation of the machine language code executed by a processor. In an embodiment, it is adapted to validate data, code, and execution flows using a third-party device or application running on the same or different system or device as described in greater detail herein. The agility of the solution provided allows safeguarding and authenticating any code compiled by a compiler and the compiler add-on, on different computing platforms, i.e., being agnostic to the underlining hardware and operating system.

It should be appreciated that systems that do not have a TCB as part of their design do not provide security of their own. By applying the teachings herein, it is possible to overcome the deficiencies of the prior art, in in particular the need to rely on current big and vulnerable kernels and create a running TCB even within a compromised system. These technical advantages and other improvement will become apparent from the descriptions provided herein in greater detail.

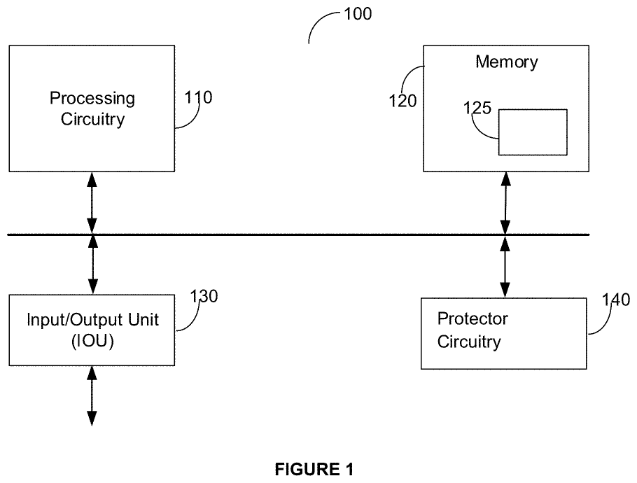

FIG. 1 is an example block diagram illustrating a computer system that comprises protected code adapted for attestation of code, data and process flows according to an embodiment. The compiler system 100 includes a processing circuitry 110 that is communicatively connected to a memory 120. The memory 120 may comprise of volatile memory, such as random-access memory (RAM) and the like, as well as non-volatile memory, such as Flash memory, read only memory (ROM) and the like. The memory 120 may contain therein code compiled by a compiler that also comprise therein one or more types of protections as discussed herein and are embedded within the assembly and/or machine code 125. The processing circuitry 110 is further communicatively connected to an input/output unit (IOU) 130. The IOU 130 provides interface connectivity to various peripherals such as displays, keyboards, input devices, output devices, as well as network connectivity. The processing circuitry 110 is further communicatively connected to a protector circuitry 140 designed to, for example but not by way of limitation, to deploy one or more validators provided in code that was embedded with the compiled code that generated the protected code 125, and may also be referred to herein as the protector 140. In an embodiment, the protector 140 may be a separate hardware device connected as shown in FIG. 1. However, this should not be viewed as precluding other embodiments where the protector 140 is implemented in software code and stored as code in memory, for example memory 120, and executed by a processor, for example the processing circuitry 110, to perform the protector 140 tasks as explained herein. In an embodiment, the protector 140 may execute on a virtual machine (VM) (not shown), where the VM is executed from code stored in memory, for example memory 120, of which an instance of the protector 140 is instantiated.

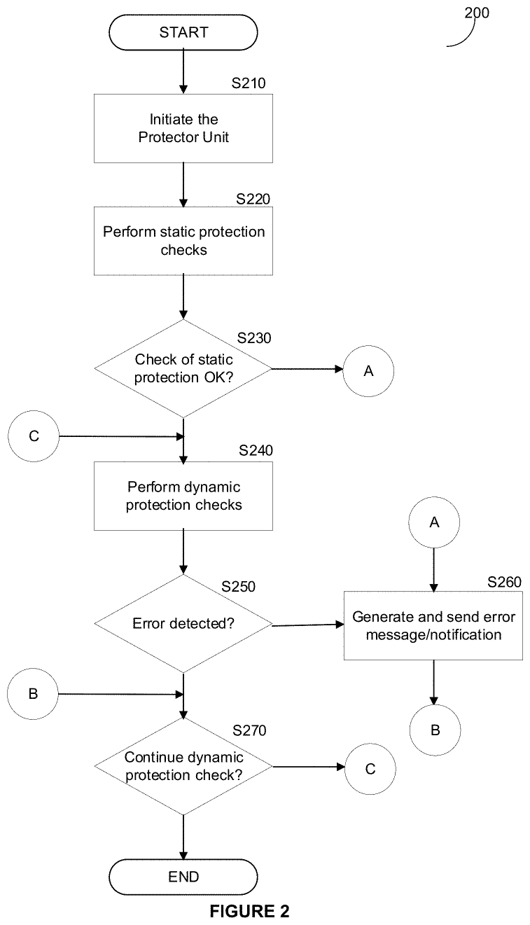

The memory 120 is configured to store software. Software shall be construed broadly to mean any type of instructions, whether referred to as software, firmware, middleware, microcode, hardware description language, or otherwise. Instructions may include code, e.g., in source code format, binary code format, executable code format, or any other suitable format of code. The instructions, when executed by processing circuitry 110, cause processing circuitry 110 to perform the various processes described herein. Specifically, when executed by processing circuitry 110, cause processing circuitry 110 to perform the various protection and attestations embedded within the compiled code, and such may further occur with the assistance of the protector 140. In one embodiment communication with the protector 140 is performed by using direct memory access (DMA) operations. To further understand the operation of the computing system 100 it is further necessary to appreciate the teachings for FIG. 2 herein.

According to an embodiment the protected code 125 is stored in the memory 120 after compilation, using a compiler add-on that provides hooks for protection of the code, data and execution flows. Various types of protections are provided within the protected code 125. For example, but not by way of limitation, validators may be included within the protected code that when executed by the processing circuitry 110 activate certain protections as explained herein in more detail. A validator is an entity, physical or virtual, which provide early warning of a developing adverse situation. The early warning allows to take preventive action before damage is made.

The protected code 125 may be further protected by a simple bit-to-bit compression algorithm along with a hash (e.g., SHA-256) calculated at compilation time. The hashing can be performed on portions of the protected text of the code and then at execution of each protected section the hash can be checked making it impossible to patch the protected area code or change it in a way that results with rouge code for execution in place of the original code, as further explained herein in greater detail. Furthermore, the protected code may contain execution proofs that are added to the code at compilation and include a) read and write execution proof [rwREF]; b) write and XOR execution proof [xREF]; and, c) write and random execution proof [uREF].

The rwREF is activated by the programmer of the code providing hints for guarding a specific area of code expected to always run in a pregiven time frame. For example, but not by way of limitation, for a function with an infinite execution loop, the programmer should mark such function and all its internal function calls as protected functions. According to an embodiment, the compiler add-on automatically inserts a sequence of assembly commands that asserts zero 64b long values to a predetermined location at the data section of the protected binary code 125. For each protected function inside the protected code there will be three unique values: 1) data location to read a 64b value (the read value); 2) code location to write a 64b value (the write value); and, 3) time interval for checking the read value (the time to check read). By providing these means of protection, during execution of the protected program the respective validators will provide the necessary proofs or alerts as may be required.

The xREF execution proof can be combined with the rwREF execution proof or be used as a standalone validation. According to an embodiment, when used in combination with the rwREF execution proof the compiler add-on inserts a sequence of assembly commands that XOR the 64-bit long value which was assigned to the rwREF execution proof. The XOR key value may be a randomly generated number by the protected code. When used as a standalone execution proof the five assembly commands can be located anywhere inside the protected function similarly to the case of the rwREF execution proof. The inserted protection acts to: randomly write random value at write value (XOR command) or read value (data location); wait for a predetermined time interval (time to check read) to lapse; and, validate that the XOR expected result from the write value and the read value that appears at the predetermined read value location. This is repeated as necessary.

The uREF is used to change specific code behavior inside the protected code. That is, polymorphing the code and/or data in such a way that does not change the semantic execution flow of the code, yet results in data, and operating system changes, that are apparent during execution of the protected code. For example, but not by way of limitation, a specific process parameter may be changed causing the code to reassign it when used later. By doing so, it is possible to introduce a random set of proofs that are executed randomly and are not visible to or copied by an attacker.

In an embodiment the execution proofs may be used as code coverage score. When used, the code coverage score enables a programmer to find out which code snippets are executing and in which pace per protected function.

The processing circuitry 110 may be realized as one or more hardware logic components and circuits. For example, and without limitation, illustrative types of hardware logic components that can be used include field programmable gate arrays (FPGAs), application-specific integrated circuits (ASICs), application-specific standard products (ASSPs), system-on-a-chip systems (SOCs), graphics processing units (GPUs), tensor processing units (TPUs), general-purpose microprocessors, microcontrollers, digital signal processors (DSPs), and the like, or any other hardware logic components that can perform calculations or other manipulations of information.

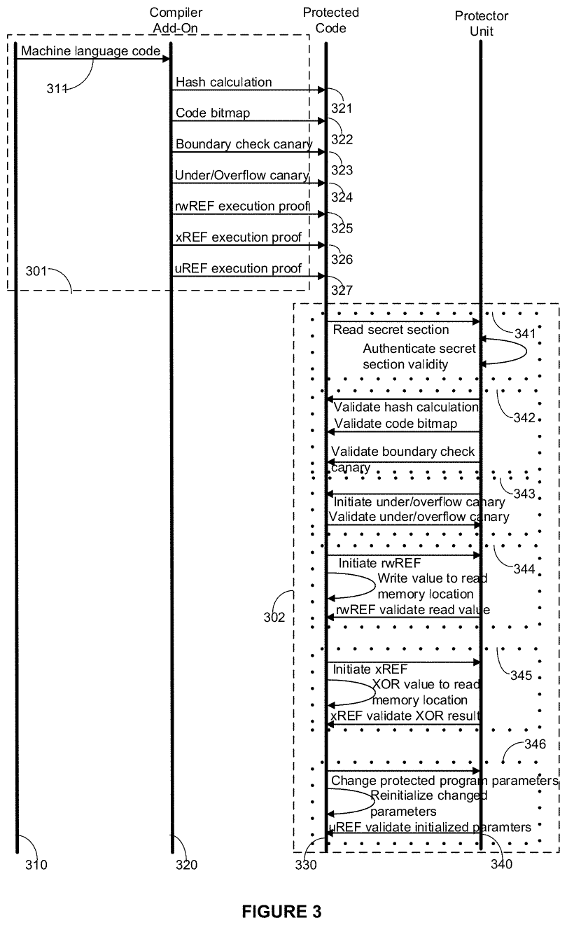

FIG. 2 is an example flowchart 200 of the operation of the computer system that executes protected code adapted for attestation of code, data and process flows according to an embodiment. The flowchart 200 is discussed with reference to the elements shown in FIG. 1. It is further understood with respect of the full attestation flow shown and discussed in FIG. 3.

At S210, an element for protecting the code is initiated. Such element may include the protector 140. At S220 static protection is performed. The static protection involves validation of the hash calculation, validation of the protected code's 125 bit-map. In addition, a boundary validation is performed by using a dedicated validator embedded in the protected code at compilation. At S230, it is checked if the static validation completed without error and if so, execution continues with S240; otherwise, execution continues with S270. At S240 dynamic protection is performed. The dynamic protection includes the deployment of data validators for protection of data, for example, but not by way of limitation, validators for overflow/underflow warnings. The dynamic protection further includes the likes of rwREF, xREF and uREF execution flow protections.

At S250, it is checked whether an error was encountered and if so, execution continues with S270; otherwise, execution continues with S270. At S260, an error notice is provided. The error notice may result in an interrupt or a trap of the normal execution of the protected code being executed thus preventing any damage that may have otherwise occurred. At S270 it is checked whether execution is to continue and if so, execution continues with S240; otherwise, execution terminates.

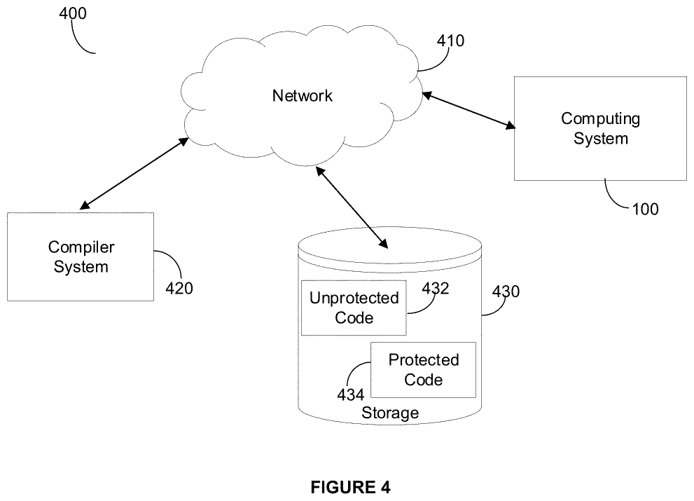

FIG. 3 is an example of a full attestation flow 300 from compiler to execution according to an embodiment. It provides to sections of the flow, one is section 301 that describes the flow between a compiler 310, a compiler add-on 320 and a resultant protected code 320, which is described in greater detail in the above-referenced '669 Application. Briefly though, the compiler 310, adapted to accept a program in one language, typically a high-level language, compiles it into the machine language code 311 of a target hardware (shown in FIG. 4 as element 432). The compiler add-on 320 receives the code 311 and generates of one or more hash calculation 321, code bitmap 322, boundary check validator 323, underflow/overflow validator 324, rwREF execution proof 325, xREF execution proof 326, and a uREF execution proof 327. The generated values, validators and execution proofs are integrated within the received code 311 (shown in FIG. 4 as element 432) resulting in the protected code 330 (shown in FIG. 4 as element 434).

The second section 302 show the process flow of the attestation when the protected compiled code is deployed. In flow 341 the protector 140 is initialized. The protector engine 140 may be a hardware engine that performs the protections described herein, a protecting application executing on the protector 140, or a protecting application executing on a VM that itself may be executed on the protector 140 or by the processing circuitry 110, all referred to herein as the protector 140 for simplicity. In an embodiment the protector engine 140 deploys multiple validators to safeguard the protected code, for example code 125. The initialization is used to identify and validate data in a secret section embedded into the protected code during compilation and that allows the validation process by the protector 140. In flow 342 additional static validations take place that include validation of the has calculation as provided during complication by the compiler add-on, validation of the code bitmap as provided by the compiler add-on, and validation of boundaries as provided for by the add-on compiler. Process flows 341 and 342 are static in that they perform their tasks at the initial point but do not continue thereafter.

Validation of protected text. When the protected code 125 is loaded to memory 120 the code is represented as text section inside the system memory. The code is protected by a simple bit to bit compresence algorithm along with a hash (SHA-256) that was calculated during compilation time by the compiler add-on. The protector 140 can constantly validate all the code and read only sections through direct memory access (DMA) on the protected memory. These protections validate all parts that do not change during execution i.e., code excluding self-modifying code) and read only (RO) data. This way it is not possible to patch the protected code or change it in a way that will result with rouge code execution replacing the original code.

Validation of protected data is partly static, for example boundary check, while others are dynamic. An artisan would appreciate that along with the code every program, and by so every protected program as well, has data sections. These sections include the parameters and resources the program may use during its execution. Global parameters are stored inside the data section memory (the process heap) and are accessible through all the program execution. Unlike local function parameters which are stored briefly on the protected thread stack during and last only through the function execution. The protector 140 deploys various data validators on both types of data sections simultaneously.

Boundary check validator. The protector 140 is adapted to automatically deduct or get hinted by the protected program what are the accepted values for each parameter in the program. Such hints are stored in protector 140 secret section as boundary restriction for any hinted parameter so it will be later validated by the protector 140 directly into the protected program memory according to the relevant hint. A non-limiting integer example may be useful. A parameter X should only allow values between 0-100. The protected program provides a validator used by the protector 140 that validated constantly validates that this range is maintained throughout the entire protected program execution time.

The process flows 343, 345, and 346 are dynamic which means that throughout the execution of the protected program the validators and the execution flows to ensure they proper operation that is dependent on the specific execution flow of the protected program.

Under\Overflow validator. During the operation of the compiler add-on parameters definitions across the protected program and during compilation are detected and an 8-byte number (2⁶⁴ unique options) is added before and after each parameter in memory. These buffer locations are stored into the secret section of the protector 140 and are reported back thereto once the program executes. When the protected program is running the protector 140 initializes the different 8-bytes with random numbers and rotates them constantly at a pre-given interval. The protector 140 always monitors which validator stores which number at any given time if it was destroyed or was different between the check intervals, where the protector 140 validates the old value and replace it with a new validator. As a result, if a parameter value is overridden then an under/overflow attack can be detected, and the protected process may be stopped or flagged by the protector 140. In the case of rwREF for each protected function inside the protected code there will be three unique values: 1) data location to read a 64b value (the read value); 2) code location to write a 64b value (the write value); and 3) time interval for checking the read value (the time to check read). By providing these means of protection, during execution of the protected program 125 and its respective validators will provide the necessary proofs or alerts as may be required. In the case of rwREF execution proof the inserted protection acts to: randomly write random value at write value (XOR command) or read value (data location); wait for a predetermined time interval (time to check read) to lapse; and, validate that the XOR expected result from the write value and the read value that appears at the predetermined read value location. This is repeated as necessary. Lastly, the uREF is used to change specific code behavior inside the protected code. That is, polymorphing the code and/or data in such a way that does not change the semantic execution flow of the code, yet results in data, and operating system changes, that are apparent during execution of the protected code. For example, but not by way of limitation, a specific process parameter may be changed causing the code to reassign it when used later. By doing so, it is possible to introduce a random set of proofs that are executed randomly and are not visible to or copied by an attacker.

As noted herein, rwREF, xREF and uREF may be used as execution proofs to ensure the integrity of execution of the protected code 125.

One of ordinary skill in the art should now appreciate that the computer circuitry 100 described in FIG. 1 then responsible for execution of the protected code 125 loaded into memory 120, according, for example, the process flow shown in FIG. 3 section 302.

FIG. 4 is an example system 400 that includes a compiler system 420 and the computing system 100 adapted for attestation of code, data and process flows according to an embodiment, which include a compiler add-on to provide means for such attestation. The compiler system 420, is operative as described, for example, in the above-referenced '669 Application.

Accordingly, it compiles a program written in a high-level language into an assembly language of a target computing system, for example computing system 100. The compiler system 420 may the unprotected code 432 in a storage 430 communicatively connected thereto through a network 410. The network 410 may comprise wired connectivity, such as but not limited to, a communication bus (serial or parallel), a local area network (LAN), a wide area network (WAN), a metro area network (MAN), and the like, as well as wireless communications such as but not limited to, cellular networks, WiFi®, Bluetooth® and the like, and any combinations thereof.

The compiler system 420 is adapted with a compiler add-on that provides certain hooks that are added to the unprotected code and stored as the protected code 434 in storage 430. In one embodiment the computing system 100, also communicatively connected to the network 410, uploads the protected code 434 from the storage 430. In another embodiment the compiler system 420 stores the protected code 434 directly into the computing system 100 as protected code 125. Once the protected code 434 is uploaded (either way) into the computing system 100, the benefits of the execution of the protected code 434 (or as referred to in Fig. as 125 once stored therein) are apparent.

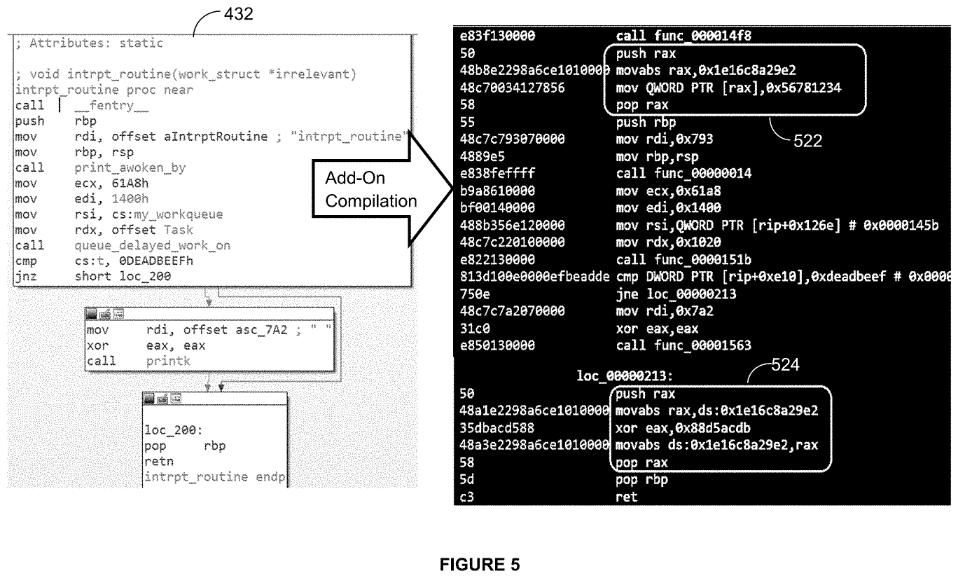

FIG. 5 is example protected compiled code read and write validator and read and XOR validator as outputted by a compiler add-on. A compiled code 432 is provided in code appropriate for the target hardware. The compiler add-on embeds into the received compiled code 432 a read and write validator 522 and a read and XOR validator 524, resulting in a protected compiled code 434. Further details of the operation of the compiler add-on are described in the above-referenced '669 Application.

It should be noted that any software or code discussed with reference to the disclosed embodiments shall be construed broadly to mean any type of instructions, whether referred to as software, firmware, middleware, microcode, hardware description language, or otherwise. Instructions may include code, e.g., in source code format, binary code format, executable code format, or any other suitable format of code.

The various embodiments disclosed herein can be implemented as hardware, firmware, software, or any combination thereof. Moreover, the software is preferably implemented as an application program tangibly embodied on a program storage unit or computer readable medium consisting of parts, or of certain devices and/or a combination of devices. The application program may be uploaded to, and executed by, a machine comprising any suitable architecture. Preferably, the machine is implemented on a computer platform having hardware such as one or more central processing units (“CPUs”), a memory, and input/output interfaces. The computer platform may also include an operating system and microinstruction code. The various processes and functions described herein may be either part of the microinstruction code or part of the application program, or any combination thereof, which may be executed by a CPU, whether or not such a computer or processor is explicitly shown. In addition, various other peripheral units may be connected to the computer platform such as an additional data storage unit and a printing unit. Furthermore, a non-transitory computer readable medium is any computer readable medium except for a transitory propagating signal.

The algorithms and displays presented herein are not inherently related to any particular computer or other apparatus. Various general purpose systems may be used with programs in accordance with the teachings herein, or it may prove convenient to construct more specialized apparatus to perform the required method. The required structure for a variety of these systems will appear as set forth in the description above. In addition, the disclosed embodiments are not described with reference to any particular programming language. It will be appreciated that a variety of programming languages may be used to implement the teachings of the invention as described herein.

As used herein, the phrase “at least one of” followed by a listing of items means that any of the listed items can be utilized individually, or any combination of two or more of the listed items can be utilized. For example, if a system is described as including “at least one of A, B, and C,” the system can include A alone; B alone; C alone; A and B in combination; B and C in combination; A and C in combination; or A, B, and C in combination.

All examples and conditional language recited herein are intended for pedagogical purposes to aid the reader in understanding the principles of the disclosed embodiment and the concepts contributed by the inventor to furthering the art, and are to be construed as being without limitation to such specifically recited examples and conditions. Moreover, all statements herein reciting principles, aspects, and embodiments of the disclosed embodiments, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

What is claimed is:

1. A computing system. comprising:
a processing circuitry;
a memory communicatively connected to the processing circuity, the memory containing therein a protected code; and
a protector circuitry connected to the processing circuitry;
such that upon execution of the protected code by the processing circuitry the computing system is configured to:
initialize the protector engine;
perform at least one static protection check using the protector circuitry;
perform at least one dynamic protection checks using the protector circuitry; and
generate a notification upon detection of an error in any one the at least one static check and the at least one dynamic check.

2. The computing system of claim 1, wherein the protector circuitry is realized as any one of: a hardware component, a software component executing on the hardware component, a software component executing on the processing circuitry.

3. The computing system of claim 2, wherein the software component executing on the processing circuitry is configured to execute a virtual machine executed on the processing circuitry.

4. The computing system of claim 1, wherein initialization of the protector circuitry comprises authentication of validity of a secret section of the protector circuitry.

5. The computing system of claim 1, wherein the computing system is further configured to:
validate by the protector circuitry a hash calculation provided within the protected code when performing the at least one static protection check.

6. The computing system of claim 1, wherein the computing system is further configured to:
validate by the protector circuitry a code bitmap provided within the protected code when performing the at least one static protection check.

7. The computing system of claim 1, wherein the computing system is further configured to:
validate by the protector circuitry of a boundary check validator provided within the protected code when performing the at least one static protection check.

8. The computing system of claim 1, wherein the computing system is further configured to:
validate by the protector circuitry of under/overflow check validator provided within the protected code when performing the at least one dynamic check.

9. The computing system of claim 1, wherein the computing system is further configured to:
validate by the protector circuitry by execution proofs provided within the protected code when performing the at least one dynamic check.

10. The computing system of claim 10, wherein an execution proof is a read and write (rwREF) execution proof.

11. The computing system of claim 10, wherein an execution proof is a write and XOR (xREF) execution proof.

12. The computing system of claim 10, wherein an execution proof is a write and random (uREF) execution proof.

13. The computing system of claim 1, wherein the computing system further comprising:
an input/output unit (IOU) connected to the processing circuitry.

14. The computing system of claim 13, wherein the protected code is loaded into the memory through the IOU.

15. The computing system of claim 13, wherein the protector circuitry is implemented as a code stored in the memory and executed by the processing circuitry.

16. The computing system of claim 15, wherein the protector circuitry is implemented as a code stored in the memory that executes on a virtual machine that is executed by the processing circuitry.

17. A method for attestation of secured code, data and execution flows, comprising:
initializing a protector circuitry executed over a processor circuity;
performing at least one static protection check using the protector circuitry;
performing at least one dynamic protection checks using the protector circuitry; and
generating a notification upon detection of an error in any one the at least one static check and the at least one dynamic check.

18. A non-transitory computer readable medium having stored thereon instructions for causing a processing circuitry to execute a process for attestation of secured code, data and execution flows, the process comprising:
initializing a protector circuitry executed over a processor circuity;
performing at least one static protection check using the protector circuitry;
performing at least one dynamic protection checks using the protector circuitry; and
generating a notification upon detection of an error in any one the at least one static check and the at least one dynamic check.
